(19) United States
(12) Patent Application Publication
(10) Pub. No.: US 2026/0140428 A1
(43) Pub. Date: May 21, 2026

(54) LINEAR ACTUATOR DEVICE SMALL IN NUMBER OF COMPONENTS AND SMALL IN GUIDE RESISTANCE, LENS BARREL, AND IMAGE CAPTURING APPARATUS

(71) Applicant: CANON KABUSHIKI KAISHA, Tokyo (JP)

(72) Inventors: KYOSUKE SATO, Kanagawa (JP); TAKUTO ICHIHARA, Tokyo (JP)

(21) Appl. No.: 19/382,632

(22) Filed: Nov. 7, 2025

(30) Foreign Application Priority Data
Nov. 18, 2024 (JP) 2024-200689

(51) Int. Cl. G03B 13/36; G02B 7/09; H02K 41/035

(52) U.S. Cl. CPC G03B 13/36; G02B 7/09; H02K 41/0354

(57) ABSTRACT

A linear actuator device including a lens assembly that has a lens, a linear actuator that linearly drives the lens assembly in a linear actuation direction, and a linear guide that has a main guide bar for supporting the lens assembly in a state movable in the linear actuation direction. The lens assembly has two main engagement portions which are arranged with a certain distance in the linear actuation direction and engaged with the main guide bar. The linear actuator is arranged between the two main engagement portions and at the same time arranged in a position overlapping the lens on a projected plane viewed from a direction orthogonal to the linear actuation direction, to apply thrust to the lens assembly in a direction substantially coinciding with the linear actuation direction.

### BACKGROUND

### Field of the Technology

The present disclosure relates to a linear actuator device small in the number of components and small in guide resistance, a lens barrel equipped with the linear actuator device, and an image capturing apparatus.

### Description of the Related Art

A linear actuator device has been widely put to practical use for a positioning mechanism of precision equipment, a conveying device, a transportation apparatus, and so forth. Linear actuator devices include one using an electromagnetic-type linear DC motor and one using a friction-type ultrasonic wave motor, and further, there is known one that converts a rotational driving force generated by driving a rotary motor to a linear driving force, by using a linear motion-converting mechanism, such as a rack-and-pinion mechanism.

For example, Japanese Laid-Open Patent Publication (Kokai) No. 2023-129928 and Japanese Laid-Open Patent Publication (Kokai) No. 2007-129824 each disclose a linear actuator device that moves a lens forward and backward in an optical axis direction within a lens barrel. Specifically, Japanese Laid-Open Patent Publication (Kokai) No. 2023-129928 discloses a configuration in which, in a case where the center of gravity of a driven body is within a lens, a plurality of linear actuators are arranged along an outer periphery of the lens. Further, Japanese Laid-Open Patent Publication (Kokai) No. 2007-129824 discloses a configuration in which a single linear actuator is arranged coaxially with a guide bar and is connected to a portion, engaged with the guide bar, of the lens holder.

According to the technique disclosed in Japanese Laid-Open Patent Publication (Kokai) No. 2023-129928, it is possible to position an action axis of thrust as a resultant force of the plurality of linear actuators, at a location close to the center of gravity of the driven body. Further, according to the technique disclosed in Japanese Laid-Open Patent Publication (Kokai) No. 2007-129824, it is possible to cause an action axis of thrust of the linear actuator to substantially coincide with the guide bar. Therefore, according to the techniques disclosed in Japanese Laid-Open Patent Publication (Kokai) No. 2023-129928 and Japanese Laid-Open Patent Publication (Kokai) No. 2007-129824, it is possible to reduce the guide resistance.

The technique disclosed in Japanese Laid-Open Patent Publication (Kokai) No. 2023-129928 has a problem that the number of components is increased and a problem that the size and weight of the lens barrel as the product tend to be increased. Further, the technique disclosed in Japanese Laid-Open Patent Publication (Kokai) No. 2007-129824 has a problem that since the portion, engaged with the guide bar, of the lens holder, and the linear actuator are arranged side by side in the optical axis direction which is a linear actuation direction, the size of the lens barrel tends to be increased in the linear actuation direction.

### SUMMARY

The present disclosure is directed to providing a linear actuator device that avoids an increase in the size, the weight, and the number of components of the linear actuator device as a product, and is small in guide resistance.

In a first aspect of the present disclosure, there is provided an linear actuator device, including a driven body that has an object to be driven, a linear actuator that linearly drives the driven body in a first direction, and a linear guide that has a main guide bar for supporting the driven body in a state movable in the first direction, wherein the driven body has two main engagement portions which are arranged with a certain distance in the first direction and engaged with the main guide bar, and wherein the linear actuator is arranged between the two main engagement portions and at the same time arranged in a position overlapping the object to be driven on a projected plane viewed from a second direction orthogonal to the first direction, to apply thrust to the driven body in a direction substantially coinciding with the first direction.

In a second aspect of the present disclosure, there is provided a linear actuator device, including a driven body, a linear actuator that drives the driven body in a predetermined first direction, and a linear guide that supports the driven body in a state movable in the first direction, wherein the driven body has two main engagement portions which are arranged with a certain distance in the first direction and engaged with the linear guide, and wherein the linear actuator is arranged between the two main engagement portions.

Features of the present disclosure will become apparent from the following description of embodiments with reference to the attached drawings. The following description of embodiments is given by way of example.

### BRIEF DESCRIPTION OF THE DRAWINGS

FIG. 1 is a view showing a schematic configuration of an image capturing system according to an embodiment.

FIG. 2 is an exploded perspective view showing a schematic configuration of a linear actuator device according to the embodiment.

FIGS. 3A to 3C are an exploded perspective view and the like useful in explaining a structural relationship between a lens assembly and a linear actuator, appearing in FIG. 2.

FIGS. 4A to 4D are schematic views useful in explaining the configurations of respective linear actuator devices according to the present embodiment and related art, and forces acting on lens assemblies of the linear actuator devices.

FIGS. 5A and 5B are cross-sectional views of the linear actuator device according to the present embodiment.

### DESCRIPTION OF THE EMBODIMENTS

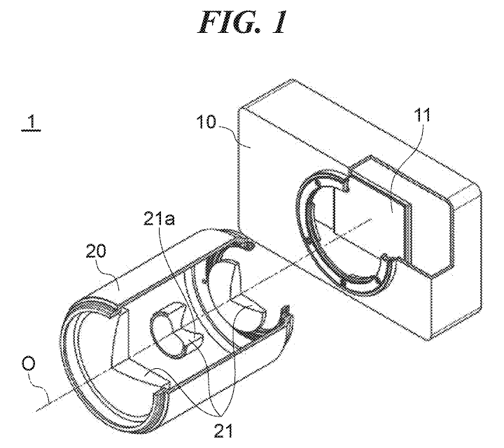

The present disclosure will now be described in detail below with reference to the accompanying drawings showing embodiments thereof. FIG. 1 is a view showing a schematic configuration of an image capturing system 1 according to an embodiment of the present disclosure. The image capturing system 1 is comprised of an image capturing apparatus 10 and a lens barrel 20 which can be removably attached to the image capturing apparatus 10. Note that the image capturing apparatus 10 and the lens barrel 20 can be integrally configured, i.e. can be configured such that the lens barrel 20 cannot be removed from the image capturing apparatus 10.

The image capturing apparatus 10 is a so-called mirrorless single-lens digital camera and includes an image sensor 11, such as a complementary metal-oxide-semiconductor (CMOS) sensor. The lens barrel 20 is one generally referred to as an interchangeable lens and includes a lens group 21. The lens barrel 20 has a mount portion having a known structure, such as a bayonet engagement structure, and is configured to be removably attachable to the image capturing apparatus 10 such that an optical axis of the lens group 21 passes through the center of an imaging surface of the image sensor 11. Incident light passing through the inside of the lens barrel 20 forms an optical image on the imaging surface of the image sensor 11, which is converted by the image sensor 11 to an image signal. Note that the image capturing apparatus 10 has no problem in being a commercial product (known technique), and hence description of the detailed configuration of the image capturing apparatus 10 is omitted.

The lens barrel 20 is configured to be capable of executing focusing (auto focus) for focusing on an object by driving a linear actuator to move a focus lens 21a, as one of lenses forming the lens group 21, forward and backward in an optical axis direction. Further, the lens barrel 20 is configured to be capable of executing zooming for adjusting a photographing angle of view by driving the linear actuator to move a zoom lens, which is one of the lenses forming the lens group 21, forward and backward in the optical axis direction.

A lens driving device for performing focusing and a lens driving device for performing zooming can have the same configuration, and the following description will be given of the lens driving device for performing focusing.

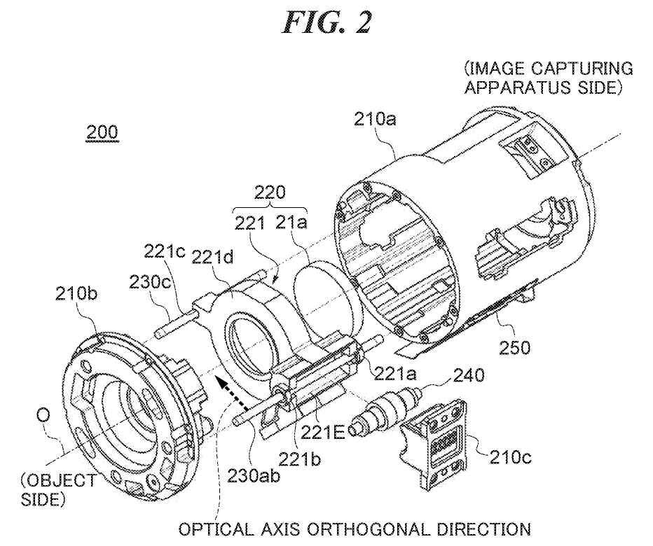

FIG. 2 is an exploded perspective view showing a schematic configuration of a linear actuator device 200 as a lens driving device provided inside the lens barrel 20. The linear actuator device 200 includes the focus lens 21a, a lens holder 221, a rear base member 210a, a front base member 210b, and a side base member 210c. Further, the linear actuator device 200 includes a main guide bar 230ab, a sub guide bar 230c, a linear actuator 240, and a linear encoder 250.

The linear actuator device 200 executes auto focus. The rear base member 210a, the front base member 210b, and the side base member 210c form a base body for holding the linear actuator device 200. The lens holder 221 is a holding member for holding the focus lens 21a and has a substantially ring-shaped holder base portion 221d as part to which the focus lens 21a is fixed. The focus lens 21a is fixed to a hole portion of the holder base portion 221d by using a method of e.g. bonding or caulking. In the following description, the lens holder 221 to which the focus lens 21a is fixed is referred to as a lens assembly 220.

The focus lens 21a is an object to be driven by the linear actuator device 200, and the lens assembly 220 is a driven body in the linear actuator device 200. A linear actuation direction of the lens assembly 220 is the optical axis direction.

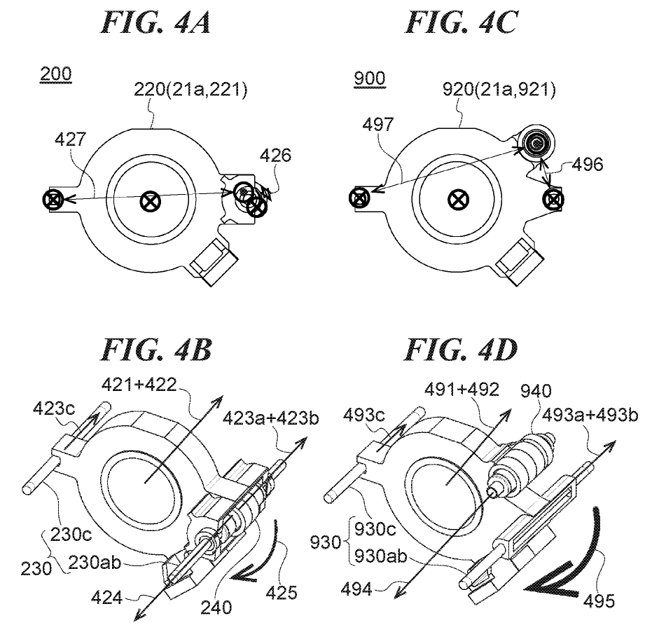

The main guide bar 230ab and the sub guide bar 230c are arranged with a certain distance (guide bar baseline length) across the lens holder 221 such that the length direction thereof is substantially parallel to a photographing optical axis O to form a linear guide 230 (see FIG. 4B as needed). As shown in FIG. 4B, referred to hereinafter, the linear guide 230 is arranged such that a plane including the respective center axes of the main guide bar 230ab and the sub guide bar 230c is close to the photographing optical axis O. The respective opposite ends of the main guide bar 230ab and the sub guide bar 230c in the length direction are fixed to the rear base member 210a and the front base member 210b.

The lens holder 221 is formed with an actuator accommodating section 221E having a substantially hollow cylindrical shape. A thrust direction of the actuator accommodating section 221E is substantially parallel to the linear actuation direction, and opposite ends of the actuator accommodating section 221E in a longitudinal direction (ends in the linear actuation direction) are formed with main engagement portions 221a and 221b, which are engaged with the main guide bar 230ab. Further, the lens holder 221 is formed with a sub engagement portion 221c which is engaged with the sub guide bar 230c. By engaging the main engagement portions 221a and 221b with the main guide bar 230ab, and engaging the sub engagement portion 221c with the sub guide bar 230c, the lens assembly 220 is supported by the linear guide 230 in a state movable in the optical axis direction.

The main engagement portions 221a and 221b each having a hollow cylindrical shape are respectively provided on the opposite ends of the actuator accommodating section 221E in the longitudinal direction with a certain distance (main guide baseline length) in the linear actuation direction and are slidably fitted on the main guide bar 230ab. That is, the main guide bar 230ab is in a state inserted in holes of the main engagement portions 221a and 221b disposed with the certain distance in the linear actuation direction.

By providing the main engagement portions 221a and 221b at the two positions on the lens holder 221, movements of the lens assembly 220 in four directions of movements, i.e. movements within a plane orthogonal to the linear actuation direction of the lens assembly 220 and pitching and yawing movements with respect to the linear actuation direction, are restricted. Note that the movements within the plane orthogonal to the linear actuation direction refer to movements in respective axial directions in a case where orthogonal coordinate axes are assumed within this plane, and the axes refer to, for example, axes in a height direction and a width direction of the image capturing apparatus 10 in a state in which the lens barrel 20 is attached to the image capturing apparatus 10.

The sub engagement portion 221c has a groove shape having a certain length in the linear actuation direction and is slidably fitted on the sub guide bar 230c. A direction in which two side walls forming the groove shape of the sub engagement portion 221c are opposed to each other (direction orthogonal to side wall surfaces of the side walls) is substantially orthogonal to a plane including a center axis of the main guide bar 230ab and a center axis of the sub guide bar 230c. With this, it is possible to prevent the lens assembly 220 from rotating (rolling) about the main guide bar 230ab of the lens assembly 220.

Thus, in the linear actuator device 200, by combining the main guide bar 230ab and the sub guide bar 230c with the main engagement portions 221a and 221b and the sub engagement portion 221c of the lens assembly 220, movements in the total five directions are restricted. At this time, the directions of movements restricted by the respective combinations do not overlap each other, and hence it is possible to obtain an effect that the influence of shapes and an arrangement error on variation of performance is small.

The linear actuator 240 is an electromagnetic-type linear DC motor having a substantially cylindrical shape and is disposed between the main engagement portions 221a and 221b in the actuator accommodating section 221E. The detailed configuration of the linear actuator 240 will be described hereinafter, and only a simple description will be given here. The linear actuator 240 is generally configured such that a cylindrical field magnet part including permanent magnets and a hollow cylindrical coil part having coils are coaxially arranged and that an action axis when the Lawrentz force generated by energizing the coils is taken out as the thrust becomes substantially parallel to the linear actuation direction. In the following description, the field magnet part of the linear actuator 240 is referred to as the field magnet part FM, and the coil portion is referred to as the coil part CP.

The field magnet part FM and the coil part CP are coaxially arranged with a constant spacing between the outer peripheral surface of the field magnet part FM and the inner peripheral surface of the coil part CP, the field magnet part FM is held in the actuator accommodating section 221E of the lens holder 221, and the coil part CP is held on the side base member 210c. A known technique can be used for wiring e.g. a power supply line to the coil part CP, and for a driving circuit that drives the linear actuator 240, and hence illustration and description thereof are omitted.

The linear encoder 250 is mounted on the rear base member 210a, for detecting a position of the lens assembly 220 in the optical axis direction relative to the rear base member 210a and the front base member 210b.

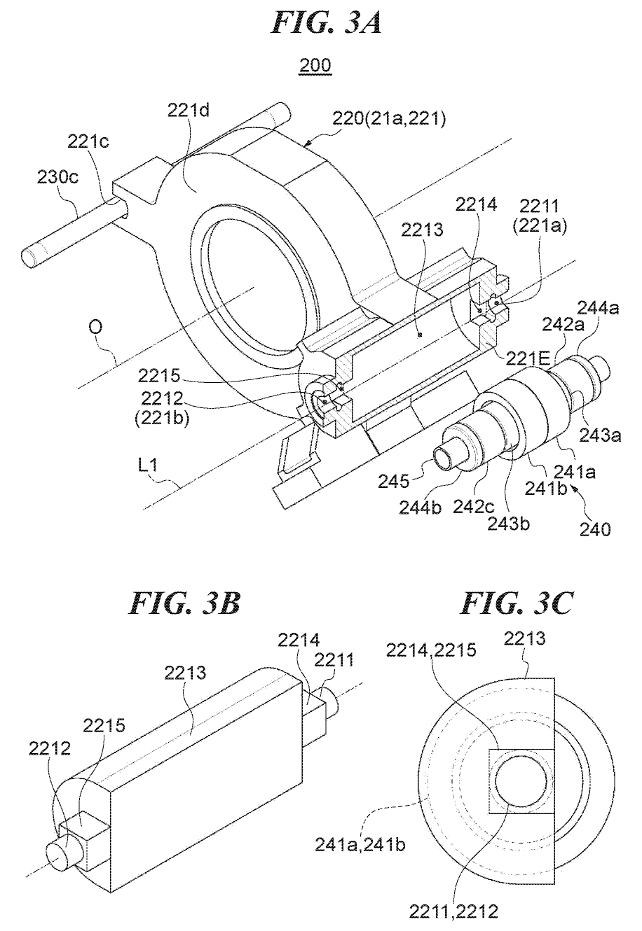

Next, the configuration of the linear actuator device 200 will be described in detail. FIG. 3A is a perspective view showing the lens assembly 220 and the linear actuator 240 in a separated state. FIG. 3A shows a center axis L1 of the main guide bar 230ab while the main guide bar 230ab is omitted from illustration. Further, in FIG. 3A, the actuator accommodating section 221E is expressed in a cross-section taken along a plane orthogonal to a plane including the photographing optical axis O and the center axis L1.

The linear actuator 240 overlaps the main engagement portions 221a and 221b of the lens holder 221 on a plane viewed from the optical axis direction as the linear actuation direction (hereinafter referred to as the “optical axis projected plane”). Further, the linear actuator 240 overlaps the focus lens 21a (holder base portion 221d) on a plane (hereinafter referred to as the “optical axis orthogonal projected plane”) which is viewed from a direction from the center axis of the main guide bar 230ab toward the photographing optical axis O (optical axis orthogonal direction). The main engagement portions 221a and 221b do not overlap the focus lens 21a (holder base portion 221d) on the optical axis orthogonal projected plane.

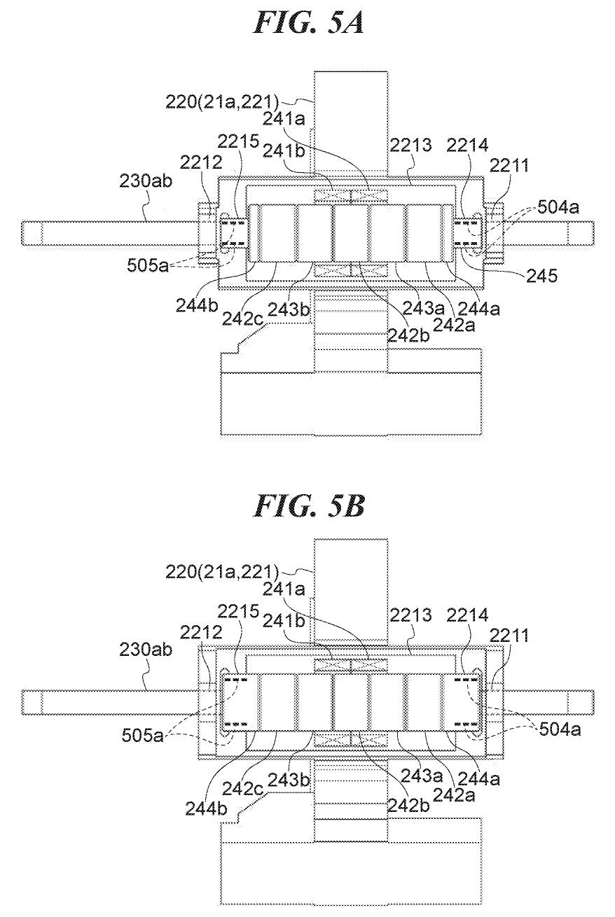

More specifically, the linear actuator 240 has two hollow cylindrical coils 241a and 241b forming the coil part CP. Further, the linear actuator 240 has three hollow cylindrical permanent magnets 242a, 242b (see FIGS. 5A and 5B), and 242c, two hollow cylindrical inner yokes 243a and 243b, two hollow cylindrical spacers 244a and 244b, and one pipe member 245. Note that the permanent magnet 242b is covered by the coils 241a and 241b, and hence the permanent magnet 242b is invisible in FIG. 3A.

The linear actuator 240 has the cylindrical field magnet part FM formed therein which has a continuous and periodic structure in the optical axis direction (see FIGS. 5A and 5B), formed by the permanent magnets 242a to 242c, the inner yokes 243a and 243b, the spacers 244a and 244b, and the pipe member 245. The linear actuator 240 has a so-called magnet-in-coil arrangement structure in which the field magnet part FM is positioned inside the coil part CP on a projected plane viewed from the thrust direction and at the same time extended in the linear actuation direction, and has a feature that it is excellent in compactness and lightness. However, for the linear actuator 240, a coil-in-magnet arrangement structure can be used in place of the magnet-in-coil arrangement structure.

The linear actuator 240 is configured as a so-called multi-magnetic pole type in which the permanent magnets 242a to 242c are arranged such that the polarity of the interlinkage flux acting on the coils 241a and 241b periodically changes within a certain stroke range in the linear actuation direction. Further, the two coils 241a and 241b as an example of the plurality of coils are arranged side by side in the linear actuation direction, and energization of the coils 241a and 241b is controlled according to the stroke position, so as to make it possible to obtain the thrust in a desired position within the stroke range with a stable efficiency. Compared with a single magnetic pole type, the multi-magnetic pole type requires a plurality of coils to be arranged side by side and energization control to be performed in this state, but has an advantage that an influence of magnetic saturation is difficult to be received and it is possible to extend the stroke range by employing a periodic structure.

In the linear actuator 240, the structure is simplified by inserting the pipe member 245 through the hollow cylindrical permanent magnets 242a to 242c, the inner yokes 243a and 243b, and the spacers 244a and 244b, which have substantially the same outer diameter and inner diameter, to hold these members. That is, to form the field magnet part of the linear actuator of the magnet-in-coil arrangement structure and at the same time of the multi-magnetic pole type, it is required to arrange a plurality of permanent magnets and inner yokes alternately along the linear actuation direction, and at the same time cause the magnetization direction of the permanent magnets to substantially coincide with the linear actuation direction. Further, it is required to make the magnetization directions of the plurality of permanent magnets, adjacent to each other via the plurality of inner yokes, opposite from each other. In this case, the plurality of permanent magnets, adjacent to each other, are in an unstable positional relationship in which the magnetic forces thereof repel each other, whereby the permanent magnets are urged to move in a direction orthogonal to the linear actuation direction. To cope with this, in the linear actuator 240, the positions of the permanent magnets 242a and 242b in the linear actuation direction in the linear actuator 240 are held to be fixed by using the pipe member 245.

The pipe member 245 is manufactured by performing a variety of processing methods, such as grinding from a bar-shaped member, extrusion, drawing, and rounding of a plate, using a nonmagnetic thin material which is small in thickness and has high mechanical strength, such as copper alloy or aluminum alloy. By making the pipe member 245 thin, it is possible to minimize an influence of the pipe member 245 on the size (magnitude) of the linear actuator 240. Further, since the nonmagnetic material is used for the pipe member 245, it is possible to prevent the pipe member 245 from lowering the driving efficiency of the linear actuator 240. Further, only by inserting the pipe member 245 through the permanent magnets 242a to 242c and the inner yokes 243a and 243b, it is possible to hold these members in the predetermined positions, and hence it is not required to separately perform bonding, additional processing, and so forth when the linear actuator 240 is assembled. That is, it is possible to form the linear actuator 240 with a simple configuration.

Note that the pipe member 245 is also a member for fixing the field magnet part FM to the actuator accommodating section 221E and protrudes from the spacers 244a and 244b at opposite ends thereof in the linear actuation direction in the field magnet part FM. Further, in place of the pipe member 245, the permanent magnets 242a to 242c, the inner yokes 243a and 243b, and the spacers 244a and 244b can be fixed by using a plate member or a wire member.

The spacers 244a and 244b are added to the front and the rear of the magnet array arranged along the linear actuation direction (arrangement of the permanent magnet 242a, the inner yoke 243a, the permanent magnet 242b, the inner yoke 243b, and the permanent magnet 242c) to adjust the whole length. Similar to the permanent magnets 242a to 242c and the inner yokes 243a and 243b, the spacers 244a and 244b can be easily arranged by inserting the pipe member 245 through the spacers 244a and 244b.

For the spacers 244a and 244b, for example, a resin member light in weight can be used. Particularly, by pressing (urging) the magnet array in one direction of the linear actuation direction by using sponge or rubber, which has elasticity, it is possible to increase the positioning accuracy of the magnet array. Note that in a case where the whole length of the magnet array can be adjusted by only one spacer, one of the spacers 244a and 244b is not required, and in a case where adjustment of the whole length of the magnet array is not required, it is unnecessary to dispose the spacer.

The field magnet part FM of the linear actuator 240 is held in the actuator accommodating section 221E by fitting the pipe member 245 in the actuator accommodating section 221E in a state in which the main guide bar 230ab slidably extends through the pipe member 245. On the other hand, the coil part CP is held by the side base member 210c. Thus, when power is supplied to the coils 241a and 241b to drive the linear actuator 240, the coil part CP and the field magnet part FM are moved relative to each other in the linear actuation direction. Here, the field magnet part FM is held by the lens assembly 220 having the actuator accommodating section 221E, and the coil part CP is held by the side base member 210c. Therefore, by driving the linear actuator 240, the lens assembly 220 is moved in unison with the field magnet part FM in the linear actuation direction relative to the base part formed by the rear base member 210a, the front base member 210b, and the side base member 210c.

Thus, the linear actuator 240 is formed as a moving magnet type in which the field magnet part FM is moved in the linear actuation direction. Compared with a moving coil type in which the fixed side and the moving body side are reversed, the moving magnet type is generally increased in mass on the moving body side and hence, the moving magnet type is disadvantageous in respect of efficiency. However, wiring is not required on the moving body side, and hence the moving magnet type has an advantage that it is possible to simplify the configuration of the moving body side and driving resistance is not generated by the wiring. Although in the present embodiment, the moving magnet type is employed so as to give priority to simplifying the configuration of the lens assembly 220 which is an object to be driven, employment of the moving magnet type is not essential, but the moving coil type can be employed to achieve power saving and the like.

In the linear actuator 240, it is required to dispose the field magnet part FM and the coil part CP so as to prevent the field magnet part FM and the coil part CP from being brought into contact with each other even when the field magnet part FM is moved relative to the coil part CP in the linear actuation direction. To satisfy this requirement, the actuator accommodating section 221E is designed such that the five space areas of a first space area 2211, a second space area 2212, a third space area 2213, a fourth space area 2214, and a fifth space area 2215 are formed, as shown in FIG. 3A. Note that the fourth space area 2214 is formed between the first space area 2211 and the third space area 2213, and the fifth space area 2215 is formed between the second space area 2212 and the third space area 2213.

FIG. 3B is a schematic view pictorially showing the first space area 2211 to the fifth space area 2215, which are formed in the actuator accommodating section 221E. FIG. 3C is a view showing a relationship between the first space area 2211 to the fifth space area 2215 and the linear actuator 240, on an optical axis projected plane.

The first space area 2211 and the second space area 2212 correspond to columnar (disc-shaped) areas through which the main guide bar 230ab is inserted, i.e. spaces of the holes of the main engagement portions 221a and 221b, in the main engagement portions 221a and 221b. Therefore, the inner diameter of the main engagement portions 221a and 221b (outer diameter of the first space area 2211 and the second space area 2212) is slightly larger than the outer diameter of the main guide bar 230ab.

The third space area 2213 is an area for accommodating the field magnet part FM and the coil part CP of the linear actuator 240 and has a substantially semi-cylindrical shape (a tunnel shape or a shape of a Japanese food, i.e. steamed fish paste on a board). A curved surface of the third space area 2213, which is parallel to the center axis L1 of the main guide bar 230ab, is, in other words, a surface of a groove having a substantially U-shaped cross section, which is formed in the actuator accommodating section 221E in parallel to the center axis L1. A flat surface of the third space area 2213, which is parallel to the center axis L1, corresponds to an opening surface of the actuator accommodating section 221E.

As is clear from FIG. 3C, the opening surface of the actuator accommodating section 221E has a width large enough to insert the field magnet part FM and the coil part CP of the linear actuator 240 in the third space area 2213 when the linear actuator device 200 is assembled. By inserting the main guide bar 230ab into the pipe member 245 of the field magnet part FM after the field magnet part FM and the coil part CP of the linear actuator 240 are inserted in the third space area 2213, it is possible to arrange the field magnet part FM coaxially with the main guide bar 230ab. Note that in a state in which the linear actuator 240 has been assembled in the actuator accommodating section 221E, part of the field magnet part FM and the coil part CP protrudes from the opening surface of the actuator accommodating section 221E on an optical axis projected plane, but there is no problem.

The outer diameter of the third space area 2213 is larger than the outer diameter of the coils 241a and 241b. In other words, a space having a predetermined width is formed between the outer peripheries of the coils 241a and 241b and the surface of the groove, having a substantially U-shaped cross section, of the actuator accommodating section 221E. Thus, the actuator accommodating section 221E and the coil part CP do not interfere with (are not brought into contact with) each other. Note that details of the fourth space area 2214 and the fifth space area 2215 and an effect obtained by disposing these areas will be described hereinafter.

Next, the linear actuator device 200 according to the present embodiment is compared with the configuration described in the above-mentioned Japanese Laid-Open Patent Publication (Kokai) No. 2023-129928 (hereinafter referred to as the “first related art”) as an example of the conventional technique. Although in the first related art, the plurality of actuators are arranged around the lens assembly, only one linear actuator is arranged in the present embodiment. Therefore, in the present embodiment, it is possible to realize reduction of the number of components, reduction of the diameter (size reduction) and the weight of the lens barrel, and it is possible to obtain an effect that the lens barrel can be easily assembled by simplifying the internal structure.

Note that in the first related art, the moving performance in the linear actuation direction is enhanced by adjusting the acting point of the thrust generated by the plurality of actuators to the approximate center of gravity of the lens assembly. In the present embodiment, the acting point of the thrust generated by the linear actuator 240 cannot be adjusted to the center of gravity of the lens assembly. However, in the present embodiment, the action axis of the thrust of the linear actuator is made substantially parallel to the linear actuation direction, and at the same time, the thrust of the linear actuator is generated substantially parallel to the linear actuation direction between the main engagement portions 221a and 221b of the lens assembly 220. In addition, although details will be described hereinafter with reference to FIGS. 4A to 4D, in the present embodiment, the guide resistance is reduced. With this configuration, the high moving performance of the lens assembly 220 in the linear actuation direction is realized.

Then, the linear actuator device 200 according to the present embodiment is compared with the configuration described in the above-mentioned Japanese Laid-Open Patent Publication (Kokai) No. 2007-129824 (hereinafter referred to as the “second related art”) as an example of the conventional technique. In the present embodiment, the linear actuator 240 is arranged coaxially with the main guide bar 230ab, and this point is the same in the second related art. The lens holder and the linear actuator do not overlap on the optical axis orthogonal projected plane in the second related art but overlap each other in the present embodiment. In the present embodiment, compared with the second related art, it is possible to reduce the size (reduce the length) in the linear actuation direction due to this difference.

In the present embodiment, the provision of the main engagement portions 221a and 221b with the predetermined distance (main guide baseline length) in the linear actuation direction does not increase the size of the linear actuator device, but this is for the following reason: The main engagement portions 221a and 221b of the lens assembly 220 are arranged with the certain main guide baseline length, so as to improve the moment load resistance performance and restrict movement, such as tilting and yawing, which causes a hindrance to linear driving of the lens assembly 220. Therefore, a certain length is required for the main guide baseline length, but it is not required to make the main guide baseline length shorten more than required, and it can be said that disposition of the linear actuator 240 in a space formed between the main engagement portions 221a and 221b does not increase the size of the linear actuator device 200.

Further, in the second related art, the thrust is generated at a location remote from a portion, engaged with the guide bar, of the lens assembly on the optical axis orthogonal projected plane in the linear actuation direction, i.e. a location remote from the center of gravity of the lens assembly on the optical axis orthogonal projected plane. Therefore, twisting can be caused on the guide bar when the lens assembly is moved forward and backward, which can lower the moving performance. On the other hand, in the present embodiment, the thrust of the linear actuator 240 is generated at a location between the two main engagement portions 221a and 221b, i.e. at a location close to the gravity center position of the lens assembly 220 on the optical axis orthogonal projected plane. Therefore, twisting is difficult to be caused on the main guide bar 230ab when the lens assembly 220 is moved forward and backward, and it is possible to maintain the high moving performance.

Next, the linear actuator 240 is compared with a third related art. FIGS. 4A and 4B are a front view and a perspective view showing arrangement of essential members of the linear actuator device 200, respectively. FIGS. 4C and 4D are a front view and a perspective view showing arrangement of essential members of a linear actuator device 900 according to the third related art, respectively. Note that members and parts, as components of the linear actuator device 900, which correspond to the members and the parts, as components of the linear actuator device 200, are each denoted by reference numeral of which hundreds place is “9” instead of “2”. For example, a lens holder 921 corresponds to the lens holder 221.

The effects obtained by the present embodiment are markedly different from those obtained by the third related art in a state in which the gravity acts in the linear actuation direction (a state in which the photographing direction faces upward, in other words, a state in which the photographing optical axis is parallel to the vertical direction), and hence the following description will be given assuming this state. Further, it is assumed that the lens assemblies 220 and 920 are each driven vertically upward (toward the sky).

In this case, self-weights 421 and 491 act on the lens assemblies 220 and 920, respectively, and hence it is required to prevent positional shifts of the lens assemblies 220 and 920, caused by the self-weights 421 and 491. Therefore, the linear actuators 240 and 940 are required to continuously output the thrusts (first thrust) corresponding to the self-weights 421 and 491 in a direction opposite to the self-weights 421 and 491.

In addition to this, in a case where the lens assemblies 220 and 920 are driven vertically upward against the gravity, the following second and third thrusts are required to accelerate each of the lens assemblies 220 and 920. The second thrust is a thrust corresponding to inertia forces 422 and 492. The third thrust is a thrust corresponding to the guide resistance, i.e. guide resistances 423a, 423b, and 423c of the linear guide 230 and guide resistances 493a, 493b, and 493c of a linear guide 930.

Thrusts 424 and 494 generated by the linear actuators 240 and 940 as the resultant force of the first to third thrusts, respectively, are larger than the self-weights 421 and 491.

Here, the thrusts 424 and 494 generated by the linear actuators 240 and 940, respectively, act in a direction opposite to the other forces (the self-weight, the inertia force, and the guide resistance), and hence the moment is generated according to the balance between the respective forces except a case where the acting axes of the forces coincide with each other. These moments are combined to act on the linear guides 230 and 930 as moment loads 425 and 495, respectively. As the moment load increases, the guide resistance also increases. Further, there is a concern that the driving performance is lowered due to occurrence of one-side contact between the lens assembly and the linear guide (guide bar), insufficient lubrication or the like. Therefore, it is desirable to reduce the moment loads on the linear guide, and the moment load 425 in the linear actuator device 200 is smaller than the moment load 495 in the linear actuator device 900. A reason for this will be described next.

In the linear actuator device 200 according to the present embodiment, since the linear actuator 240 is arranged coaxially with the main guide bar 230ab, the action axes of the thrust 424 and the guide resistances 423a and 423b substantially coincide with each other on the optical axis projected plane. Therefore, a moment component generated by these forces can be made to be approximately 0 (zero). On the other hand, in the linear actuator device 900 according to the third related art, the linear actuator 940 and a main guide bar 930ab are remote from the optical axis projected plane. Therefore, the moment component generated by these forces have a certain magnitude.

An inter-action axes distance 426 between the action axes of the thrust 424 and the guide resistances 423a and 423b and an inter-action axes distance 427 between the action axes of the thrust 424 and the guide resistance 423c, in the linear actuator device 200, are indicated in FIG. 4A. An inter-action axes distance 496 between the action axes of the thrust 494 and the guide resistances 423a and 423b and an inter-action axes distance 497 between the action axes of the thrust 494 and the guide resistance 423c, in the linear actuator device 900, are indicated in FIG. 4C.

The inter-action axes distance 426 in the linear actuator device 200 is shorter than the inter-action axes distance 496, which corresponds to the inter-action axes distance 426, in the linear actuator device 900. On the other hand, the inter-action axes distance 427 in the linear actuator device 200 is longer than the inter-action axes distance 497, which corresponding to the inter-action axes distance 427, in the linear actuator device 900. Therefore, the moment component generated by the thrust 424 and the guide resistance 423c becomes larger than the moment component generated by the thrust 494 and the guide resistance 423c.

Here, when focused on a change in the moment component generated by the thrust and the guide resistance, in general, the amount of change in the moment component is larger for a reduced amount than for an increased amount. More specifically, the reduced amount of the moment component generated by the thrust 424 and the guide resistances 423a and 423b is larger than the increased amount of the moment component generated by the thrust 424 and the guide resistance 423c. In the case of the linear actuator device 200, the main guide bar 230ab supports a larger force, such as the moment load caused by the self-weight, than the sub guide bar 230c. In the linear actuator device 900, the lens assembly 920 is engaged with the main guide bar 930ab at the engagement portions at two locations, and further, the linear actuator 940 is arranged at a location closer to the main guide bar 930ab than a sub guide bar 930c. Therefore, also in the linear actuator device 900, similar to the linear actuator device 200, the main guide bar 930ab supports a larger force, such as the moment load caused by the self-weight, than the sub guide bar 930c. Therefore, in the linear actuator device 200, the guide resistances 423a and 423b generated in the main guide bar 230ab are larger than the guide resistance 423c generated in the sub guide bar 230c, and this is the same in the linear actuator device 900. Further, as described hereinabove, the sub guide bar regulates only one degree of freedom (rotation about the main guide bar), and hence the guide load is smaller than in the main guide bar 230ab which regulates four degrees of freedom, and therefore, the increased amount of the moment component is small. Therefore, the moment load 425 generated in the linear actuator device 200 is smaller than the moment load 495 generated in the linear actuator device 900.

Thus, in the present embodiment, compared with the third related art, it is possible to reduce the guide resistance by reducing the load acting on the main guide bar 230ab, which makes it possible to improve the driving characteristics.

Next, the usefulness of provision of the fourth space area 2214 and the fifth space area 2215 in the actuator accommodating section 221E of the lens assembly 220 as a component of the linear actuator device 200 will be described.

FIG. 5A is a side view showing the linear actuator device 200 and its neighboring components, as viewed from a direction orthogonal to the optical axis. Note that FIG. 5A shows the coils 241a and 241b in cross sections. The fourth space area 2214 and the fifth space area 2215 are spaces formed by fitting portions (recess portions) formed in the actuator accommodating section 221E so as to fix the field magnet part FM of the linear actuator 240 to the lens assembly 220.

In the linear actuation direction, the fourth space area 2214 is formed between the first space area 2211 and the third space area 2213, and the fifth space area 2215 is formed between the second space area 2212 and the third space area 2213, respectively. The fourth space area 2214 and the fifth space area 2215 are each formed in a substantially cubic shape, as shown in FIG. 3A.

The length of one side of the fourth space area 2214 is larger than the diameter of the first space area 2211 but smaller than the diameter of the third space area 2213, in the vertical direction in FIG. 5A. Similarly, the length of one side of the fifth space area 2215 is larger than the diameter of the second space area 2212 but smaller than the diameter of the third space area 2213, in the vertical direction in FIG. 5A.

The outer diameter of the pipe member 245 as a component of the field magnet part FM of the linear actuator 240 is designed to be slightly larger than a width between wall surfaces of the fitting portions (recess portion) forming the fourth space area 2214 and the fifth space area 2215 in the actuator accommodating section 221E. Therefore, the opposite ends of the pipe member 245 in the linear actuation direction are accommodated in the fourth space area 2214 and the fifth space area 2215, respectively, without entering the first space area 2211 and the second space area 2212, and at the same time are fitted and held in the fitting portions of the actuator accommodating section 221E. Further, the permanent magnets 242a to 242c, the inner yokes 243a and 243b, and the spacers 244a and 244b, which are larger in outer diameter than the pipe member 245 in the field magnet part FM, do not enter the fourth space area 2214 and the fifth space area 2215, and are arranged in the third space area 2213. Thus, all members forming the field magnet part FM of the linear actuator 240 are stably accommodated and held in the actuator accommodating section 221E.

Note that an adhesive can be poured into remaining spaces 504a and 505a of the fourth space area 2214 and the fifth space area 2215 and solidified therein after the pipe member 245 is accommodated in the fourth space area 2214 and the fifth space area 2215. With this, it is possible to more rigidly fix the field magnet part FM of the linear actuator 240 in the actuator accommodating section 221E.

FIG. 5B shows a variation of the configuration shown in FIG. 5A. In the variation shown in FIG. 5B, the fourth space area 2214 and the fifth space area 2215 are each formed such that the length thereof in the radial direction of the main guide bar 230ab within the optical axis orthogonal projected plane is equal to that of the third space area 2213. That is, the fourth space area 2214 and the fifth space area 2215 are formed by extending the third space area 2213 toward the first space area 2211 and the second space area 2212, respectively.

Further, in the linear actuator 240, the pipe member 245 is not used, and the field magnet part FM is formed by fixing the permanent magnets 242a to 242c, the inner yokes 243a and 243b, and the spacers 244a and 244b to each other, with an adhesive. By forming the field magnet part FM without using the pipe member 245, it is possible to transfer the volume of the pipe member 245 to an increased volume of the permanent magnets or the inner yokes, which improves the efficiency.

The spacers 244a and 244b positioned on the opposite ends of the field magnet part FM formed by bonding are fitted in the fitting portions forming the fourth space area 2214 and the fifth space area 2215, respectively, whereby the field magnet part FM is held in the actuator accommodating section 221E. An adhesive can be poured into remaining spaces 504a and 505a of the fourth space area 2214 and the fifth space area 2215 and solidified therein after the spacers 244a and 244b are accommodated in the fourth space area 2214 and the fifth space area 2215. With this, it is possible to more rigidly fix the field magnet part FM of the linear actuator 240 in the actuator accommodating section 221E.

The present disclosure has been described heretofore based on the preferred embodiments thereof. However, the present disclosure is not limited to these embodiments, but it is to be understood that the disclosure includes various forms within the scope of the gist of the present disclosure. Further, the embodiments of the present disclosure are described only by way of example, and it is possible to combine the embodiments as deemed appropriate.

For example, although, in the above-described embodiment, the multi-magnetic pole type linear actuator is used for the linear actuator device, the effects related to arrangement of the linear actuator can also be obtained by using a single magnetic pole type linear actuator. Further, the linear actuator device according to the present embodiment can be applied not only to the lens assembly as the driven body, but also to a variety of devices which include a driven body required to be linearly moved.

According to the present disclosure, it is possible to avoid an increase in the size and weight of a product and an increase in the number of components and realize the linear actuator device which is small in guide resistance.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-200689, filed November 18, 2024, which is hereby incorporated by reference herein in its entirety.

What is claimed is:

1. A linear actuator device, comprising:
a driven body that has an object to be driven;
a linear actuator that linearly drives the driven body in a first direction; and
a linear guide that has a main guide bar for supporting the driven body in a state movable in the first direction,
wherein the driven body has two main engagement portions which are arranged with a certain distance in the first direction and engaged with the main guide bar, and
wherein the linear actuator is arranged between the two main engagement portions and at the same time arranged in a position overlapping the object to be driven on a projected plane viewed from a second direction orthogonal to the first direction, to apply thrust to the driven body in a direction substantially coinciding with the first direction.

2. The linear actuator device according to claim 1, wherein the linear actuator has a field magnet part and a coil part, both having a substantially hollow cylindrical shape,
wherein the field magnet part and the coil part are coaxially arranged with a constant spacing between an outer peripheral surface of the field magnet part and an inner peripheral surface of the coil part, and at the same time the main guide bar extends through the field magnet part, and
wherein the field magnet part is fixed to the driven body, and the coil part is fixed to a base holding the main guide bar without being brought into contact with the driven body.

3. The linear actuator device according to claim 2, wherein the driven body has an accommodating section having a substantially semi-cylindrical shape, for accommodating the linear actuator,
wherein a thrust direction of the accommodating section is substantially parallel to the first direction,
wherein the two main engagement portions are formed into a substantially hollow cylindrical shape at opposite ends of the accommodating section in the first direction, and
wherein the main guide bar extends through the two main engagement portions, and the linear actuator is arranged between the two main engagement portions in the accommodating section.

4. The linear actuator device according to claim 3, wherein the driven body has a holding member for holding the object to be driven, and
wherein the accommodating section is formed in the holding member.

5. The linear actuator device according to claim 3, wherein the accommodating section has fitting portions in which ends of the field magnet part in the first direction are fitted.

6. The linear actuator device according to claim 5, wherein the field magnet part has a plurality of hollow cylindrical permanent magnets and a plurality of hollow cylindrical yokes, which are alternately arranged in the first direction, and a pipe member extending through the plurality of permanent magnets and the plurality of yokes, and
wherein in the field magnet part, the pipe member protrudes at opposite ends thereof in the first direction and is fitted in the fitting portions.

7. The linear actuator device according to claim 6, wherein the pipe member is bonded to the fitting portions with an adhesive.

8. The linear actuator device according to claim 5, wherein the field magnet part has a plurality of hollow cylindrical permanent magnets and a plurality of hollow cylindrical yokes, which are alternately arranged in the first direction, and spacers arranged at opposite ends of the field magnet part in the first direction, and
wherein an outer diameter of the permanent magnets, an outer diameter of the yokes, and an outer diameter of the spacers are substantially equal to each other, and
wherein the spacers are fitted in the fitting portions.

9. The linear actuator device according to claim 8, wherein the spacers are bonded to the fitting portions with an adhesive.

10. The linear actuator device according to claim 1, wherein the two main engagement portions do not overlap the object to be driven, on a projected plane viewed from the second direction.

11. The linear actuator device according to claim 1, wherein the object to be driven is a focus lens or a zoom lens, and
wherein the first direction is an optical axis direction of the focus lens or the zoom lens.

12. The linear actuator device according to claim 11, wherein the linear guide has a sub guide bar which is arranged substantially parallel to the main guide bar with a certain distance across the optical axis of the focus lens or the zoom lens, and the driven body has a sub engagement portion which is engaged with the sub guide bar to restrict rotation of the driven body about the main guide bar.

13. A linear actuator device, comprising:
a driven body;
a linear actuator that drives the driven body in a predetermined first direction; and
a linear guide that supports the driven body in a state movable in the first direction,
wherein the driven body has two main engagement portions which are arranged with a certain distance in the first direction and engaged with the linear guide, and
wherein the linear actuator is arranged between the two main engagement portions.

14. A lens barrel having a linear actuator device that moves a lens assembly formed by holding a lens on a lens holder, in an optical axis direction,
wherein the linear actuator device includes:
a linear actuator that drives the lens assembly in the optical axis direction; and
a linear guide that has a main guide bar for supporting the lens assembly in a state movable in the optical axis direction,
wherein the lens assembly has two main engagement portions which are arranged with a certain distance in the optical axis direction and engaged with the main guide bar, and
wherein the linear actuator is arranged between the two main engagement portions and at the same time arranged in a position overlapping the lens on a projected plane viewed from a direction orthogonal to the optical axis direction, to apply thrust to the lens assembly in a direction substantially coinciding with the optical axis direction.

15. An image capturing apparatus comprising:
a lens barrel having a linear actuator device that moves a lens assembly formed by holding a lens on a lens holder in an optical axis direction; and
an image sensor that converts an optical image formed by incident light passing through the lens barrel to an image signal,
wherein the linear actuator device includes:
a linear actuator that drives the lens assembly in the optical axis direction; and
a linear guide that has a main guide bar for supporting the lens assembly in a state movable in the optical axis direction,
wherein the lens assembly has two main engagement portions which are arranged with a certain distance in the optical axis direction and engaged with the main guide bar, and
wherein the linear actuator is arranged between the two main engagement portions and at the same time arranged in a position overlapping the lens on a projected plane viewed from a direction orthogonal to the optical axis direction, to apply thrust to the lens assembly in a direction substantially coinciding with the optical axis direction.
